(19) United States
(12) Patent Application Publication
(10) Pub. No.: US 2017/0146804 A1
(43) Pub. Date: May 25, 2017

(54) SOLID STATE DISPLAY VISION ENHANCEMENT

(71) Applicant: Tidal Optics LLC, Portland, OR (US)

(72) Inventors: Erik Nackerud, Portland, OR (US); Doug Childers, Portland, OR (US)

(73) Assignee: Tidal Optics LLC, Portland, OR (US)

(21) Appl. No.: 15/361,327

(22) Filed: Nov. 25, 2016

Related U.S. Application Data
(60) Provisional application No. 62/259,864, filed on Nov. 25, 2015.

(51) Int. Cl. G02B 27/02; G02B 5/26; G02C 7/10; G02B 5/22

(52) U.S. Cl. CPC G02B 27/022; G02B 5/223; G02B 5/26; G02C 7/104

(57) ABSTRACT

An apparatus comprising a human vision solid state display filter material with a first and a second surface with a semitransparent material between. The first surface, the second surface, the semitransparent material or combinations thereof have a spectral pass-band and an off-band, the pass-band comprising at least three spectrally discrete bands that overlap with emission peaks from a solid state display and the off-band rejecting a portion of the human visible spectrum. Wherein a transmitted ratio of the pass-band to the off-band increases human visual perception of the solid state display when viewed under ambient light conditions.

### RELATED APPLICATIONS

This application claims benefit to U.S. provisional patent application No. 62/259,864 filed on Nov. 25, 2015.

### TECHNICAL FIELD OF THE DISCLOSURE

The present disclosure relates in general to human visions aids. The disclosure relates in particular to solid state display contrast enhanced human vision aids.

### DISCUSSION OF BACKGROUND

Solid state displays are difficult to view in high ambient light levels making devices viewing frustrated or impossible. Current solutions are directed towards increasing display brightness to achieve a higher signal-to-noise. For mobile solid state displays, for instance cell phones, increasing brightness helps viewability but dramatically decreases battery life. Attempts at addressing the issue have included blinds, antireflective coating, diffusive screens and some eyewear coating but none have had true efficacy.

The current disclosure relates to another approach.

### SUMMARY OF THE DISCLOSURE

In one aspect an apparatus of the present disclosure is a filter comprising with a first and a second surface with a semitransparent material between, wherein the first surface, the second surface, the semitransparent material or combinations thereof have a spectral pass-band and an off-band, the pass-band being a portion of a solid state displays emission and the off-band rejecting a portion of the human visible spectrum such that a transmitted ratio of the pass-band to off-band increases human visual perception of the solid state display.

The apparatus can further be corrected to account for the human psychophysics color response. For instance the pass bands and the off-bands can be adjusted in shape, bandwidth, and magnitude to maintain a constant white point or a constant color temperature. The apparatus can be corrected for color temperatures to approximate particular sources such as a solid state display, indoor lighting fixtures, outdoor lighting, or natural sources such as the sun.

The apparatus can be corrected for overall transmission based on typical usage models and psycho-human vision response. For instance, the apparatus can be corrected for perceived color interpretation in low light level conditions.

In some embodiments the apparatus is implemented in a pair of spectacles such as sunglasses or visors. In other embodiments the apparatus is implemented as flexible materials that can be adhesively applied to solid-state displays.

### BRIEF DESCRIPTION OF THE DRAWINGS

The accompanying drawings, which are incorporated in and constitute a part of the specification, illustrate methods and embodiments of the present disclosure. The drawings together with the general description given above and the detailed description of methods and embodiments given below, serve to explain principles of the present invention.

FIG. 1 is a cross-section view, partly in perspective view of a scene wherein the apparatus of the present disclosure is employed, the apparatus is a filter with a first and a second surface with a semitransparent material between, wherein the first surface, the second surface, the semitransparent material and combinations thereof have a spectral pass-band and off-band, the pass-band being a portion of a solid state displays emission and the off-band rejecting a portion of the human visible spectrum such that a transmitted ratio of the pass-band to off-band increases human visual perception of the solid state display, wherein the filter material is implemented in a pair of sunglasses.

FIG. 2A is a graphical representation of the human vision spectral response.

FIG. 2B is a graphical representation of an OLED solid-state display and a phosphor based LED display.

FIG. 3 is a graphical representation of logarithmic and power curves for the human psycho-physics response.

FIG. 4 is a reflective filter design.

FIG. 5 is an absorptive filter design.

FIG. 6A is a perspective view of the filter implemented as sunglasses.

FIG. 6B is a cross-section view of that shown in FIG. 6A

FIG. 7 is a perspective view of the filter implemented as an adhesive cover for a solid-state display.

### DETAILED DESCRIPTION OF THE INVENTION

The present disclosure provides an apparatus for increased viewability of solid-state displays. The apparatus includes a filter material with a first and a second surface, and at least semitransparent material between. The first surface, the second surface, the semitransparent material or combinations thereof have spectral bands including a pass-band and an off-band. The pass-band is a portion of a solid-state displays spectral emission and the off-band is a portion of the human visible spectrum, wherein a transmitted ratio of the pass-band to the off-band increases a human's visual perception of the solid state display in ambient light conditions.

The solid-state display can be light emitting diode (LED) or laser based. Such solid-state displays include mobile phones, tablets, computers, televisions, and projectors. LED based solid-state displays include organic (OLED) and LED-phosphor based displays. Laser based solid state displays are used in microprojectors, projectors and televisions. Color rendering with solid state display is based off red, green, and blue (RGB) bands wherein any color within the defined color gamut can be display. The apparatus of the present disclosure can be implemented and applied to any solid-state display that has spectral characteristics similar to those aforementioned.

In some embodiments the human visual perception is based on Weber-Fechner's logarithmic human eye response model. In other embodiments the human visual perception is based on Steven's power law. The increased human visual perception can be based on human adaption to overall brightness levels or non-adaptive changes. The increased human visual perception is preferably enhanced by at least 2, 3, 4, or 5 times. Some embodiments include gradient transmission filters with non-uniform transmission with respect imaging into the human eye to increase perceived display brightness.

The Weber-Fechner law, refers to the logarithmic proportionality of human subjective change to physical stimulus. Under the Weber-Fechner law, it is generally recognized that vision response is nonlinear on a log scale. This can be described basically as R=log(I), where R is the visual response to an intensity I. Therefore, in order to have 2× enhanced contrast in human visual perception the actual physical contrast must be an order of magnitude different, or 10×.

Steven's power law, refers to power proportionality of human perceived subjective change to physical stimulus. This can be described as R=kI^{a}, where R is the subjective magnitude of the sensation, I is the physical stimulus and a is the power exponent that depends on the stimulation. For vision, the power exponent a for perceived brightness as a function of physical luminance is typically between 0.25 and 0.35. Therefore, and similar to the Weber-Fechner law, in order to have a 2× enhanced contract in human vision perception the actual physical contract is about a magnitude of order different, or 10×, although the actual number can be calculated based on the power exponent. A realization of the current applicants is the need to a provide a physical difference in transmittance, taking into account the spectral output of the solid-state display and human color response, that is at least a magnitude of order, or more different than what would be expected in a traditional filter design.

The pass-bands are determined based at least in part on the spectral output of the solid-state display and the human color response. A typical LED based solid-state display has a blue-band, a green-band, and a red-band. The blue band has a peak blue emission that ranges from 445-455 nanometers (nm), the green-band has a peak emission ranges from 525-545, and the red-band has a peak emission from 590-630 nm. The shape and bandwidth of each of the bands varies depending on the technology, but the blue band is typically more spectrally discrete than the green and blue band.

Similarly, the human color response is based on human receptors called cones and rods. The cones and rods are dispersed within the back of the human eye. Color interpretation is based on absorption a blue cone, a green cone, and a red cone and the human's psycho response to those signals. The blue cone has a peak spectral sensitivity at about 445 nm, the green cone at about 535 nm, and the red cone at about 575 nm. The rods are generally only responsive at low light levels and human interpretation is in grey scale. The rods have a peak absorption wavelength of about 498 nm. Rod response can generally be ignored at high ambient light level conditions, known as photopic vision. For ambient or transmitted light levels in the mid-range, known as mesopic, the rods influence color sensitivity, requiring the pass-bands to have increased transmittance relative to other wavelengths to maintain color temperature.

Generally, the pass-bands are determined by multiplying the human response spectrum by the spectral output of the solid-state display. The resulting spectrum is analyzed to find three wavelength bands corresponding to a red pass-band, a green pass-band and a blue pass-band. The areas not defined by the pass-bands are the off-bands. The spectral bandwidth and transmission of the red pass-band, the green pass-band, and the blue pass-band are determined together with the transmission of the off-bands taking into respect practical realities such as available absorptive materials and limitation in dielectric filter designs. The spectral location and bandwidth of each of the bands can be adjusted to maintain a constant color temperature. The constant color temperature can be based on adjusted or non-adjusted human response.

Color adjustments to the filter can be accomplished by changing the transmission, bandwidth, shape, or combinations thereof of the pass-bands and the off-bands. CIE's color matching functions can be calculated and CIE xy chromaticity determined. Adjustments to the pass-bands and the off-bands can be made to match the at least approximate previous chromaticity point of the solid-state display, or be adjusted based on the brightness adaption.

The semitransparent material must be at least semitransparent to visual wavelengths. The semitransparent material can be plastic or glass based and incorporate absorptive materials such as dopants or chromophores to absorb the off-band wavelengths. The first surface and the second surface of the filter can be coated with a reflective coating to reflect the off-bands and transmit the pass-bands. The filter can incorporate both absorptive materials and reflective coatings. When the semitransparent material is to be applied to the solid-state display an adhesive layer or material can be added. For the filters which are applied to a solid-state display, antireflective coating can be applied.

Referring now to the drawings, wherein like components are designated by like reference numerals. Methods and embodiments of the present disclosure are described in further detail hereinbelow.

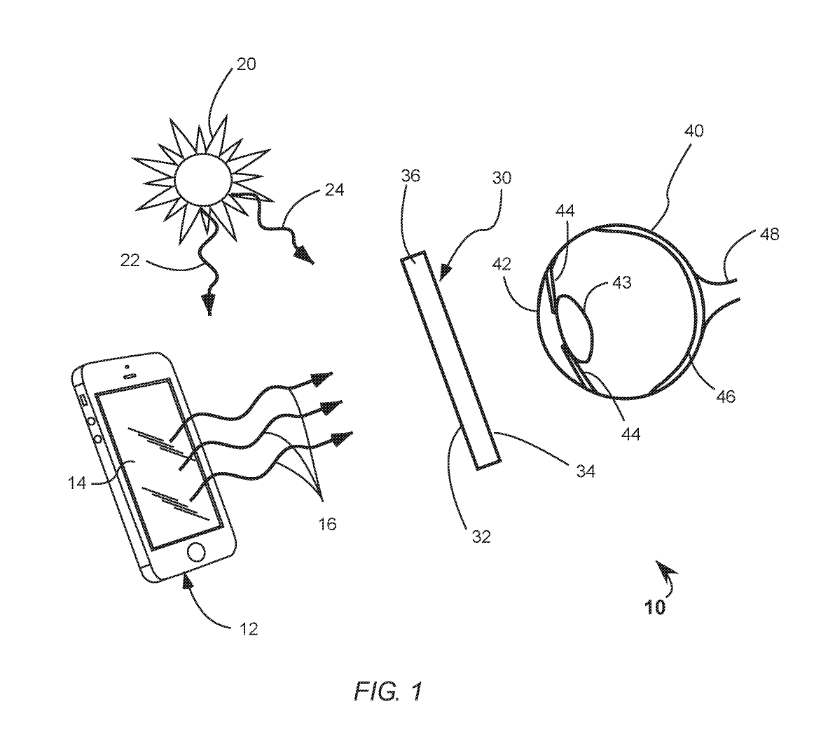

Referring to FIG. 1, a scene 10 illustrates a situation faced by a user when trying to view a solid-state display in high ambient light levels. Scene 10 has a solid-state display 12, an ambient light source 20, a filter 30, and cross-section view of a human eye 40. With the exception of filter 30, scene 10 is typical of a user viewing a solid-state display in an ambient light conditions.

Solid-state display 12 is a mobile phone with an LCD display. Solid-state display 12 has a screen 14 that emits RGB radiation directed at least partly towards human eye 40 shown as SS-rays 16. Ambient light source 20, here the sun, emits a broadband spectral radiation that covers the entire visible spectrum. A sun-ray 22 and a sun-ray 24 are directed towards solid-state display 12 and areas around the solid-state display causing directs reflection and ambient illuminated areas to reflect off screen 14 towards human eye 40 making viewing difficult.

Filter 30 has a first surface 32, a second surface 34, and a semitransparent material 36. First surface 32, second surface 34, or combinations thereof have a reflective coating. Semitransparent material 36 can be doped with aforementioned absorptive materials. Filter 30 transmits the aforementioned pass-bands and reflects the aforementioned off-bands.

Human eye 40 has a cornea 42, and iris 44, a lens 43, a retina 46 and an optic nerve 48. The cornea and lens image the solid-state display onto the back of the eye or retina 46. Retina 46 contains the aforementioned cones and rods. In order for the human eye to have a perceivable change in human contrast on the order of 2× or greater, filter 30 must reflect or absorb off-bands such that the ratio of transmitted RGB radiation to transmitted ambient light according to stevens or weber-fechner's law.

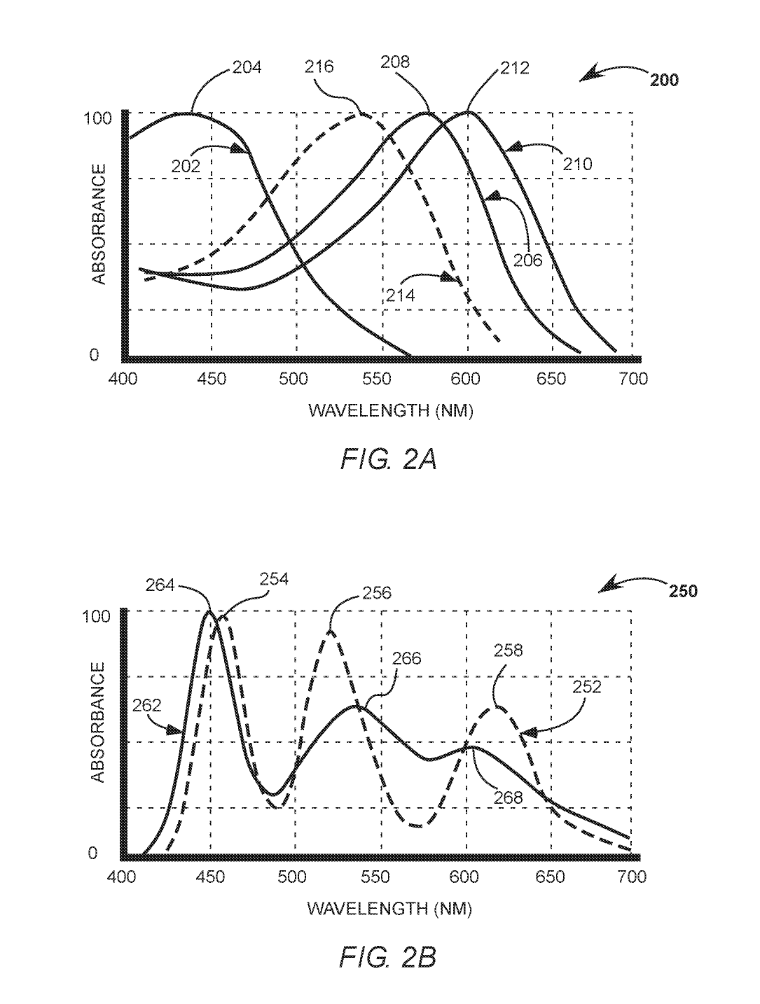

Referring to FIG. 2A, a graph 200 shows the spectral response of the human vision systems cones and rods. The cones response are drawn as solid lines and the rod response is drawn as a dashed line. A blue spectral response 202 of the blue cone has a spectral peak 204 at about 420 nm. A green spectral response 206 of the green cone has a spectral peak 208 at about 534 nm. A red spectral response 210 of the red cone has a spectral peak 212 at about 564. A rods spectral response 498 has a spectral peak 216 at about 498 nm. As vision ambient light levels reduce, or light levels limited in transmittance to the human eye through the filter, the rods begin to be stimulated and the overall spectral response blue shifts. In order to maintain the same color temperature or white point at mesopic vision levels a relative increase red pass-band transmittance is required.

Referring to FIG. 2B, a graph 250 shows the spectral output of an OLED solid-state display and an LED-phosphor based solid-state display. OLED RGB spectral output 252 has a blue peak 254, a green peak 256, and a red peak 258. LED-phosphor RGB output 252 has a blue peak 264, a green peak 266, and a red peak 268. In comparison, OLED RGB spectral output 252 has deep notches between each of the spectral peak and faster sidewalls than LED phosphor RGB output 262. The spectral peaks position between the two solid-state displays are different. In designing the filter the spectral output from either display can be used and multiplied by the human spectral response curve. Alternatively, a universal or average design can be made by averaging the relative spectral output or each display and multiplying the resultant combined spectra by the human spectral response.

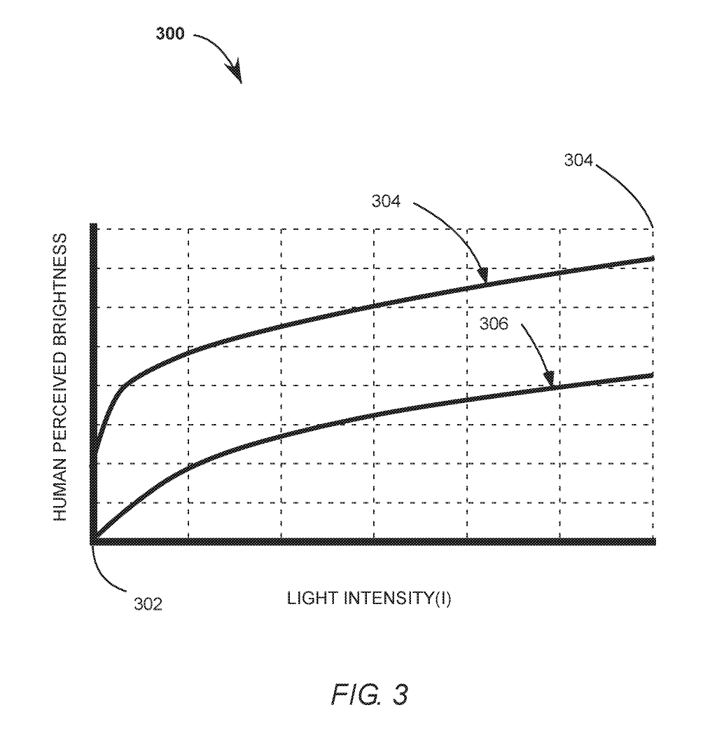

Referring to FIG. 3, a graph 300 shows human perceived brightness verse light intensity according to Stevens power law and Weber-Fechner's law. The horizontal axis is limited to a scotopic region 302 and photopic region 304. A Weber-Fechner curve 302, with exponent a at 0.25 and a Stevens power curve 306 have an offset according to the calculation, yet relative to one another, the slope is about the same in the majority of the graph.

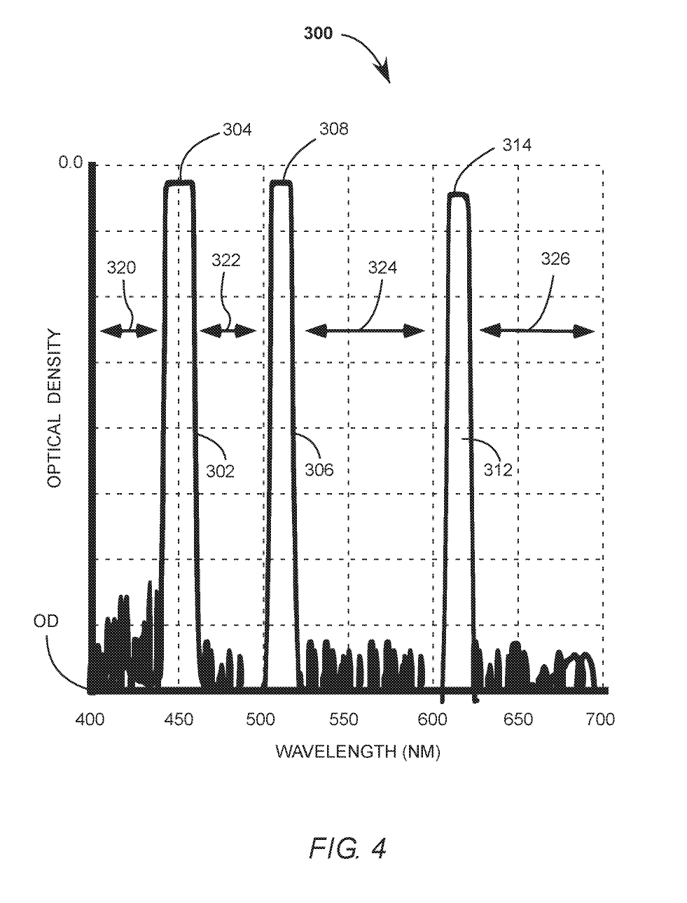

Referring to FIG. 4, a reflective filter design 300 has a pass-band and an off-band. Reflective filter design 300 transmits the pass-band and reflects the off-band characterized in transmission graph of optical density verse wavelength. An optical density of zero is 100% transmission. The pass band has a blue pass-band 302 with a blue spectral peak 304, a green pass-band with a green spectral peak 308, and a red pass-band with a red spectral peak 314. Each of the pass bands have a spectral bandwidth. The off-band is designed to reflect all wavelengths not within the pass-band. The off-band is comprised of an off-band 320, an off-band 322, an off-band 324, and an off-band 326.

An optical density attenuation OD defines the attenuation of the graph. Characterizing the filter is convenient as it is a logarithmic scaled unit. Filter designs can be made with the optical density OD at 2, 3, 4, 5, 6, or 7. Here, each of the off-bands are attenuated by about the same, although in other embodiments the off-band can be attenuated in varying degrees. The pass-bands are transmitted about the same in order to maintain a constant color temperature, the spectral bandwidth of the blue, green, and red pass-bands maintaining the same ratio of transmitted light, relative to one another, as the solid-state display in which the filter design is based. The filter can be designed using any commercially available thin film software such as Optilayer, MacCleod, S-Spectra, or Filmstar. In designing such filter it is preferable to include an angle of incidence of 5 degrees or more in order to have adequate viewing angle for the solid-state display.

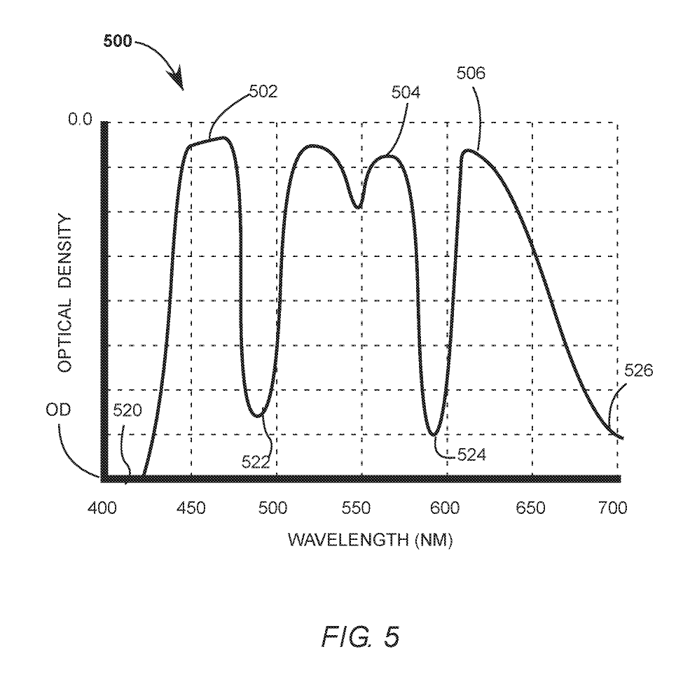

Referring to FIG. 5, and absorptive filter 500 is characterized similar to the reflective filter shown in FIG. 4. Absorptive filter has a pass band that comprises of blue pass band 502, green pass-band 504, and red pass band 506. The off-bands are characterized by an absorption peak 520, 522, 524, and 526. Here the absorption is based on dyes dissolved an incorporated into plastics, for instance polycarbonate. The shape of the absorptive filter is based on the concentration and different types of dyes incorporated in the semitransparent material as well as the overall thickness of the filter. Color balancing can be achieved by varying the dye concentrations or by adding a reflective filter to the first surface or the second surface. Visible optical dyes to create the absorptive filter are available from a variety of manufacturers including Exciton, Moleculum, and Thermofisher.

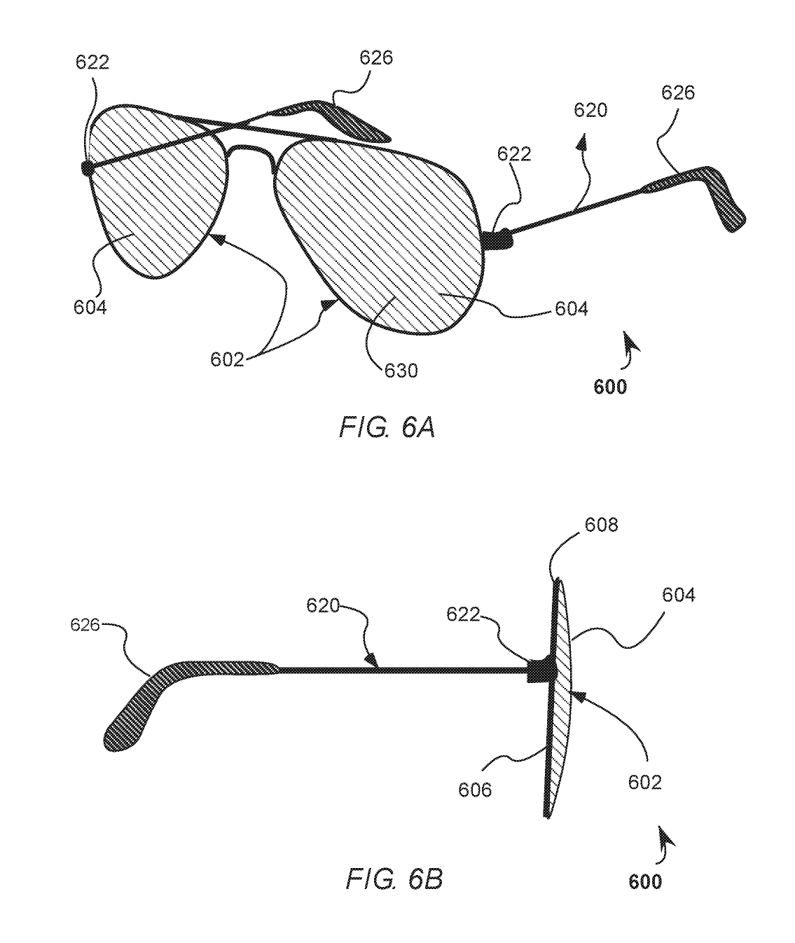

Referring to FIGS. 6A and 6B, a filter is implemented as a pair of sunglasses 600. Sunglasses 600 are bisymmetric and each side being the same characterized with reference numerals that apply to both sides. Sunglasses 600 have a frame 620 with an ear support 626, a hinge 622 and lens holder 680 that hold a filter 602. Filter 602 has a first surface 604 and a second surface 606 with a semitransparent material within. Filter 602 have spectral bands including a pass-band and an off-band as described above. Such a design can be made using aforementioned reflective, absorptive, or combinations thereof. In addition, the sunglasses first surface or the second surface can be treated with a spectrally neutral transmission gradient filter such that light in the lower center portion 630 of the filter has high transmission compared to other areas. The gradient can be linear or nonlinear.

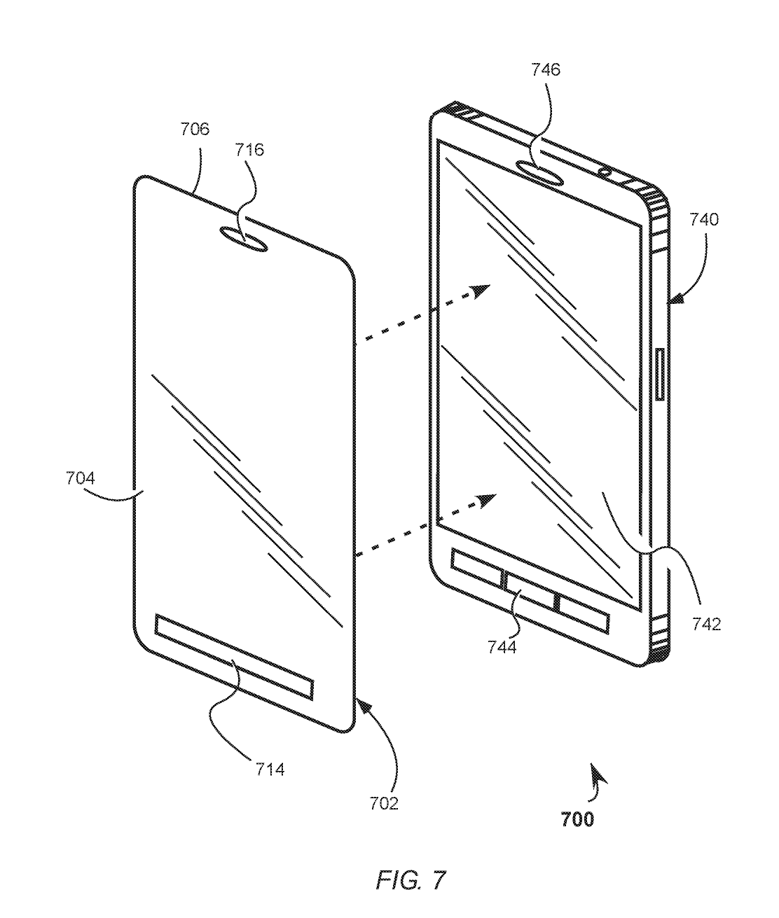

Referring to FIG. 7, a filter implemented as an adhesive cover 700 shows a filter 702 and a phone 740. Filter 702 has a first surface 704, a second surface 706. The filter is applied to a display 742 with an opening 714 and an opening 716 for a button set 714 and a speaker 746. As before the filter has a pass-band and an off-band, although here, the off-band is preferably absorbed and reflection minimized. In one preferred embodiment first surface 704 has an antireflective coating.

The present disclosure is described in terms of certain methods and embodiments. It will be understood that the invention is not limited to those specific methods and embodiments but only limited by the claims appended hereto.

What is claimed is:

1. An apparatus comprising:
A human vision solid state display filter material with a first and a second surface with a semitransparent material between;
wherein the first surface, the second surface, the semitransparent material or combinations thereof have a spectral pass-band and an off-band, the pass-band comprising at least three spectrally discrete bands that overlap with emission peaks from a solid state display and the off-band rejecting a portion of the human visible spectrum; and
a transmitted ratio of the pass-band to the off-band increases human visual perception of the solid state display when viewed under ambient light conditions.

2. The apparatus of claim 1, wherein the area under the curve of the pass-bands to the off-bands is at least 10.

3. The apparatus of claim 1, wherein the area under the curve of the pass-bands to the off-bands is at least 100.

4. The apparatus of claim 1, wherein the area under the curve of the pass-bands to the off-bands is at least 1000.

5. The apparatus of claim 1, wherein the first surface has a dielectric coating.

6. The apparatus of claim 1, wherein the second surface has an adhesive layer.

7. The apparatus of claim 1, wherein the at least semitransparent material is a polymer loaded with absorptive chromophores.

8. The apparatus of claim 1, wherein the at least semitransparent material is polycarbonate.

9. The apparatus of claim 1, wherein the at least semitransparent material has laser dye additive.

10. The apparatus of claim 1, wherein the at least semitransparent material has inorganic additives.

11. The apparatus of claim 1, wherein the semitransparent material is a glass.

12. The apparatus of claim 1, wherein the pass-band's spectrally discrete bands are centered at the peak transmission of the red, green, and blue spectral peaks of the solid state display.

13. The apparatus of claim 1, wherein the pass-band's spectrally discrete bands are located at the center of mass of the red, green, and blue emission bands.

14. The apparatus of claim 1, wherein the off-band has an average optical density of at least 2, at least 3, at least 4, or at least 5.

15. The apparatus of claim 1, wherein the pass-band and the off-band compensate for the human pschyo-physics response according to Weber's law, Web-Fechner's law, Stevens law, or combinations thereof.

16. The apparatus of claim 1, wherein the apparatus is eyewear.

17. The apparatus of claim 1, wherein the apparatus is a protective display cover.

18. The apparatus of claim 1, wherein the pass band's spectral bandwidth, magnitude, area under curve or combinations thereof maintain a constant color temperature CCT, white point, or combinations thereof.

19. The apparatus of claim 1, wherein the solid-state display is an OLED.

20. The apparatus of claim 1, wherein the solid-state display is laser based.
